(19) United States
(12) Patent Application Publication
(10) Pub. No.: US 2026/0124707 A1
(43) Pub. Date: May 7, 2026

(54) POWER TOOL ADAPTIVE CONTROL BASED ON MULTI-DIRECTION FORCE SENSOR GRIP

(71) Applicant: Milwaukee Tool Electric Corporation, Brookfield, WI (US)

(72) Inventor: Andrew J. Paskov, Brookfield, WI (US)

(21) Appl. No.: 19/379,479

(22) Filed: Nov. 4, 2025

Related U.S. Application Data
(60) Provisional application No. 63/716,989, filed on Nov. 6, 2024.

(51) Int. Cl. B23Q 15/12; B25F 5/02

(52) U.S. Cl. CPC B23Q 15/12; B25F 5/026

(57) ABSTRACT

A power tool system and method including a multi-direction force sensor and a power tool, the power tool having a motor, a trigger, and an electronic controller coupled to the multi-direction force sensor and the trigger. The electronic controller receives a trigger signal from the trigger; receives a force signal from the multi-direction force sensor; determines a directional force applied to the power tool by a user based on the force signal and the trigger signal; and controls the motor based on the directional force.

### RELATED APPLICATIONS

This application is based on, claims priority to, and incorporate herein by reference in their entirety US Provisional Application Serial No. 63/716,989, filed November 6, 2024.

### SUMMARY

Some embodiments of the disclosure provide a method for controlling a power tool. The method includes receiving, via a trigger on the power tool, a trigger signal; receiving, via an electronic processor, a force signal from a multi-direction force sensor of a handle of the power tool; determining, based on the force signal and the trigger signal, a directional force applied to the power tool by a user; and controlling a motor of the power tool based on the directional force.

Some embodiments of the disclosure provide a power tool multi-direction force sensor system. The system includes a multi-direction force sensor and a power tool. The power tool includes a motor; a trigger; and an electronic controller including a processor and coupled to the multi-direction force sensor, the motor, and the trigger. The electronic controller is configured to: receive a trigger signal from the trigger; receive a force signal from the multi-direction force sensor; determine a directional force applied to the power tool by a user based on the force signal and the trigger signal; and control the motor based on the directional force.

### BRIEF DESCRIPTION OF THE DRAWINGS

The accompanying drawings, which are incorporated in and form a part of this specification, illustrate embodiments of the disclosure and, together with the description, serve to explain principles of the embodiments:

FIGS. 1A and 1B show a power tool with multi-direction force sensors, according to some examples.

FIGS. 1C-1E show diagrams of a cross section of a handle of a power tool with different force sensor spacings, according to some examples.

FIGS. 2A-2H show various power tools with multi-direction force sensors, according to some examples.

FIG. 3 shows a block diagram of a power tool with multi-direction force sensors, according to some examples.

FIG. 4 shows a flowchart of a process for controlling a power tool motor, according to some examples.

FIGS. 5A-5B show a power tool with multi-direction force sensors and corresponding force labels, according to some examples.

FIG. 6 shows a flowchart of a process for controlling a power tool motor, according to some examples.

### DETAILED DESCRIPTION

Power tools can be used for various application in different environments. A user may apply various forces to the power tool during operation. The detection of these force can improve the performance of the tool by identifying a desired reaction of the tool in response to specific forces applied.

Some embodiments described herein provide improved systems and methods for controlling a power tool using one or more multi-direction force sensors. For example, some embodiments of the disclosure provide a power tool that has multiple force sensors in the handle or grip area of the power tool. The force sensors may monitor a grip force of a user operating the power tool to indicate a directional force applied to the handle or grip area (e.g., a push force, a pull force, a rightward force, a leftward force, etc.). The power tool may sense and determine the directional force to control parameters associated with the performance of the power tool for adaptive control of the tool.

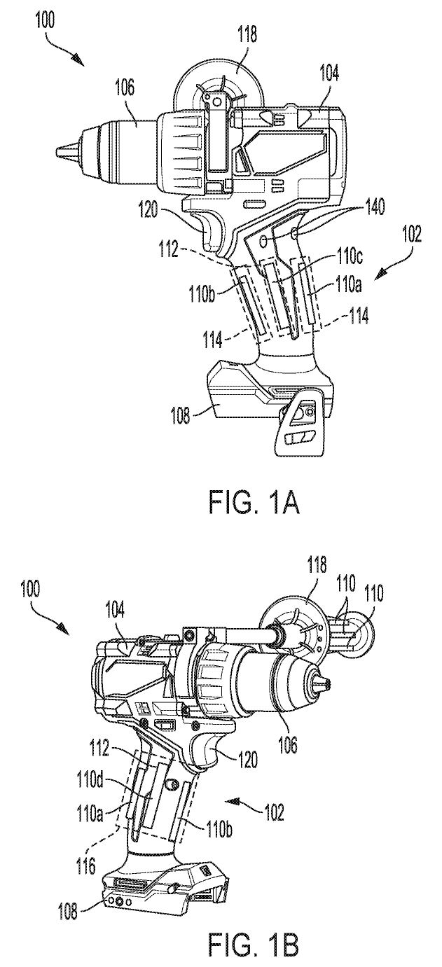

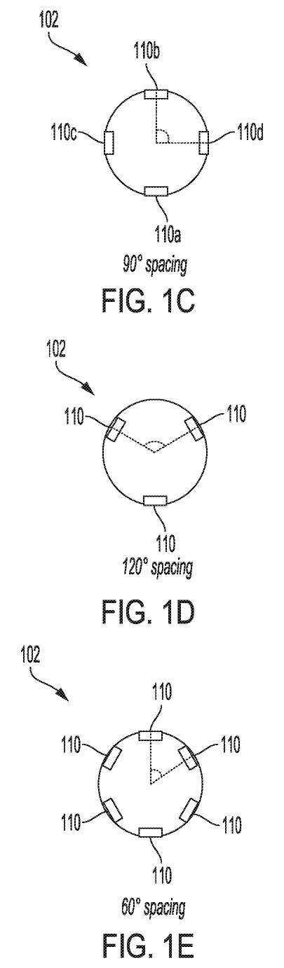

FIGS. 1A and 1B illustrate an example embodiment of a power tool 100 with force sensors 110a-d, according to some examples. The power tool 100 includes a handle or grip 102, a main body 104 housing a motor (not shown), a tool holder or chuck 106, and a foot 108 including a battery interface for selectively receiving a power tool battery pack. In this example, the power tool 100 is shown as a drill-driver, and the handle 102 (also referred to as the main handle 102) extends from the main body 104 towards the foot 108. Further, the tool holder 106 is in front of the main body 104. In some examples, as illustrated, the power tool 100 further includes an auxiliary handle or grip 118 that is separate from the handle 102. In FIG. 1A, the auxiliary handle 118 is attached to the main body 104 on a right side of the power tool 100. In FIG. 1B, the auxiliary handle 118 is attached to the main body 104 on a left side of the power tool 100.

A first multi-direction force sensor 112 may include the force sensors 110a and 110b. In some examples, the multi-direction force sensor 112 may also be referred to as a force sensor cluster 112 or multi-direction force sensor cluster 112. In particular, the first multi-direction force sensor 112 may sense a force on the front of the handle 102 (e.g., via

force sensor 110b) and a force on the back of the handle 102 (e.g., via force sensor 110a). Moreover, a second multi-direction force sensor 112 may include the force sensors 110c and 110d. The second multi-direction force sensor 114 may sense a force on the left side of the handle 102 (e.g., via force sensor 110c) and a right side of the handle 102 (e.g., via force sensor 110d). Together, the first and second multi-direction force sensors 112 and 114 may form a multi-axis force sensor 116, which may also be referred to as a multi-axis force sensor cluster 116. The force sensors 110a-d may be referred to generically and/or collectively as the force sensor(s) 110. Although four force sensors 110a-d are illustrated in FIGS. 1A and 1B, in some examples, the power tool 100 includes fewer or more force sensors 110 that may form multi-direction force sensors 112, 114, and/or multi-axis force sensors 116.

As noted, in some examples, the power tool 100 can include the auxiliary handle or grip 118. In addition to or instead of the force sensors 110a-d, the auxiliary handle 118 may include two or more force sensors 110 that may sense additional forces being applied to the auxiliary handle 118 by a user. For example, the force sensors 110 of the auxiliary handle 118 may be paired on opposite sides of the auxiliary handle 118 (similar to the force sensors 110a-d on the handle 102) to form a third multi-direction force sensor and a fourth multi-direction force sensor, respectively. Further, the third and fourth multi-direction force sensors, and the force sensors 110 thereof, may form an additional multi-axis force sensor for the auxiliary handle 118 (similar to the multi-axis force sensor 116 of the handle 102). Accordingly, the force sensors 110 on the auxiliary handle 118, when present, can, for example, sense and indicate a force on a front, back, top, and/or bottom of the auxiliary handle 118.

FIGS. 1C, 1D, and 1E illustrate a diagram of a cross section of the handle 102 looking down through the handle 102 from a top of the handle 102, where the handle is approximated in the diagram as a cylinder (thus, providing a circular cross-section). FIG. 1C illustrates the force sensors 110 in the arrangement as shown in FIGS. 1A and 1B, with pairs of force sensors 110a, 110b and 110c, 110d on opposite sides of one another. In this example, the force sensors 110a-d may be described as having an approximately 90 degree spacing around the handle. As used herein when referring to degrees, approximately refers to a particular degree within a tolerance of +/- 5, 10, or 15 degrees. In some examples, the positions of the force sensors 110 around the handle 102 may not be opposite to one another. For example, in FIG. 1D, the handle 102 includes three force sensors 110 spaced out at an interval of approximately 120 degrees around the handle. In the example of FIG. 1E, the handle 102 includes six force sensors 110 spaced out at an interval of approximately 60 degrees around the handle. In other examples, the spacing of the force sensors 110 around the circumference of the handle may be another value other than 60, 90, and 120, such as, for example, a spacing of between 30 to 100 degrees, 100 to 180 degrees, or 30 to 180 degrees around the handle. Moreover, in some examples, the spacing between force sensors 110 around the circumference of the handle may be irregular (e.g., two force sensors 110 spaced apart by 30 degrees, and each of these force sensors 110 spaced apart 150 degrees from another respective force sensor 110). Additionally, although the handle 102 and handles of various power tools described herein may not be perfectly cylindrical, such spacing around the handle may nevertheless be measured from a central longitudinal axis through such handles.

In some examples, the force sensors 110 are at the same height in the handle 102. In other examples, the force sensors 110 are at two or more varying heights in the handle 102. As used herein, height in the handle 102 refers to the longitudinal position along the length of the handle 102 (e.g., generally vertical position along the handle 102 in the drawing of FIG. 1A). Although two force sensors 110 may be at different heights in the handle, they may still be referred to as opposite one another. For example, with reference to FIG. 1C, force sensor 110a and 110b may be considered opposite one another (e.g., measuring a push and pull force, respectively, on the handle 102). However, the force sensor 110a and the force sensor 110b may be at different heights in the handle 102. For example, with reference back to FIG. 1A, the force sensor 110a may be higher than the force sensor 110b, which may be due to the ergonomics of the handle 102 and the power tool 100. Nevertheless, the force sensors 110a and 110b may be considered opposite one another because, for example, in the diagram of FIG. 1C, the spacing between the force sensor 110a and 110b is approximately 180 degrees.

Given the rotational axis of the motor and a drill bit or driver bit that may be coupled to the tool holder 106 for driving by the motor, a force sensed on the left side of the handle 102 or on the right side of the handle 102 by one or more of the force sensors 110 may also be referred to, respectively, as a counter-clockwise force or a clockwise force on the power tool 100. Similarly, a force on the top side of the auxiliary handle 118 (in FIG. 1B) or on the bottom side of the auxiliary handle 118 (in FIG. 1B) by one or more of the force sensors 110 may be referred to, respectively, as a clockwise force or a counter-clockwise force on the power tool 100.

As illustrated in FIGS. 1A and 1B, the power tool 100 can include a trigger 120 on the handle 102. The trigger 120 may be a mechanical switch used to detect an engagement of the trigger 120 by a user of the power tool 100. For example, the trigger 120 may produce an actuation signal to indicate how far the user has pressed down the trigger 120. In some examples, a handle of the power tool 100 including the trigger 120 may be considered the main handle (e.g., the handle 102), while another handle of the power tool 100 may be considered an auxiliary handle (e.g., the auxiliary handle 118). In some examples, the trigger 120 may take other physical forms, such as a paddle switch, a thumb switch, a lever, a push button, etc.

The force sensor(s) 110 may include a force sensitive resistor (FSR), a strain gauge, a capacitive pressure sensor, another sensor, an inductive sensor, or a combination thereof. Although not shown in FIGS. 1A and 1B, the force sensor(s) 110 may be connected to additional circuitry. For example, in some embodiments, a force sensor 110 may be an FSR that senses a direct force applied by a user’s grip. The FSR may be connected to circuitry that can include a bias resistor. In another example, one or more of the force sensors 110 may be strain gauges that sense an indirect force by detecting a flexion or strain applied to a housing of the power tool (e.g., the handle). For example, the strain gauge may measure a resistance between two or more points on the force sensor 110c, 110d. An increase in resistance may indicate an increased tension or force applied to the power tool 100, while a decrease in resistance may indicate a decreased tension or force applied to the power tool 100. Each strain gauge may be positioned on an inner surface of the handle 102 at a point of greatest or increased handle flex in response to left, right, rear, or front force applied to the handle 102. For example, four strain gauges may be located on front, rear, left, and right sides of the handle 102 on an upper half or third of the handle 102 (e.g., respective strain gauges for left and rear force sensors may be located at points 140 in FIG. 1A). Moreover, in some examples, one or more of the force sensors 110 may be a capacitive pressure sensor that can detect a direct force using capacitive sensing via one or more resistor-capacitors and/or inductor capacitors.

As illustrated, the power tool 100 is a motorized power tool. That is, the power tool 100 is a power tool that includes a motor. In some examples, the power tool 100 is another type of motorized power tool. Each type of motorized power tool can include a moveable component and an actuator (e.g., a motor) that can move (e.g., translate, rotate, reciprocate, oscillate, etc.) the moveable component to implement a functionality on a workpiece. For example, a motorized power tool can be a drill or drill-driver, an impact driver, an impact wrench, a hammer drill-driver, a crimper, a cutter, a reciprocating saw, a circular saw, a chainsaw, a pump, a fan, or the like. In other examples, the power tool 100 is a nonmotorized power tool. Thus, although shown as a particular type of power tool in FIGS. 1A and 1B, the power tool 100 can be implemented as various types of power tools, including as a motorized power tool or a non-motorized power tool. As used herein, a “power tool device” may include a power tool (whether motorized or non-motorized), a power tool battery pack, a power tool battery pack charger, or a combination thereof.

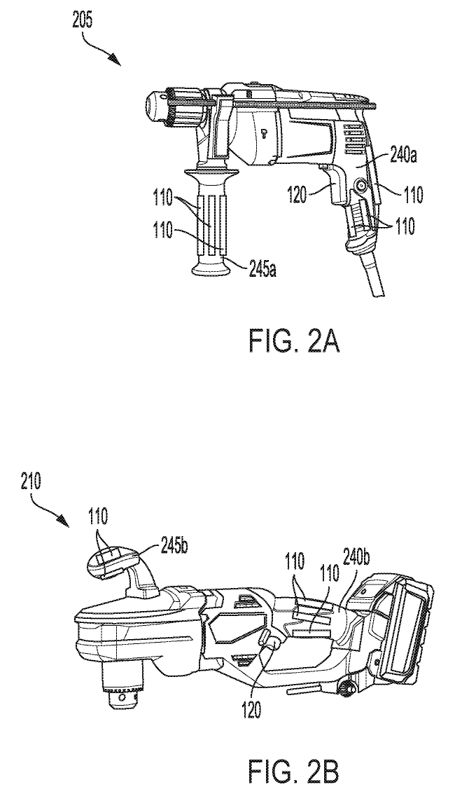

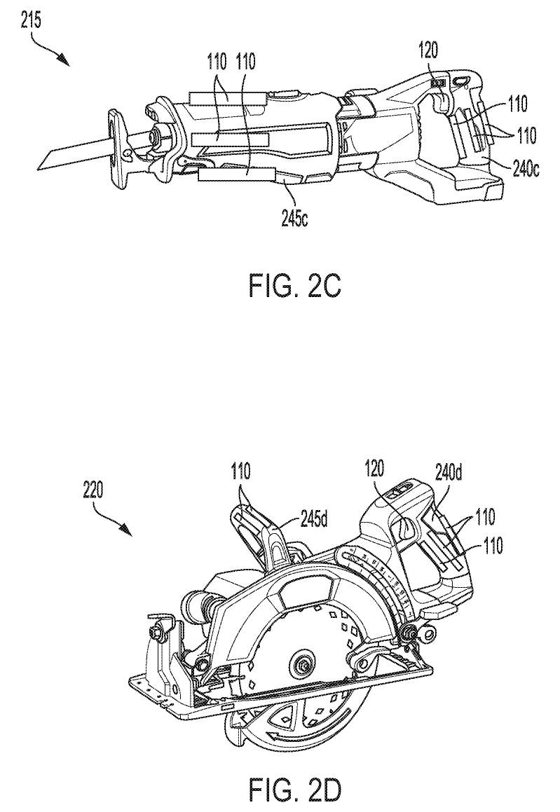

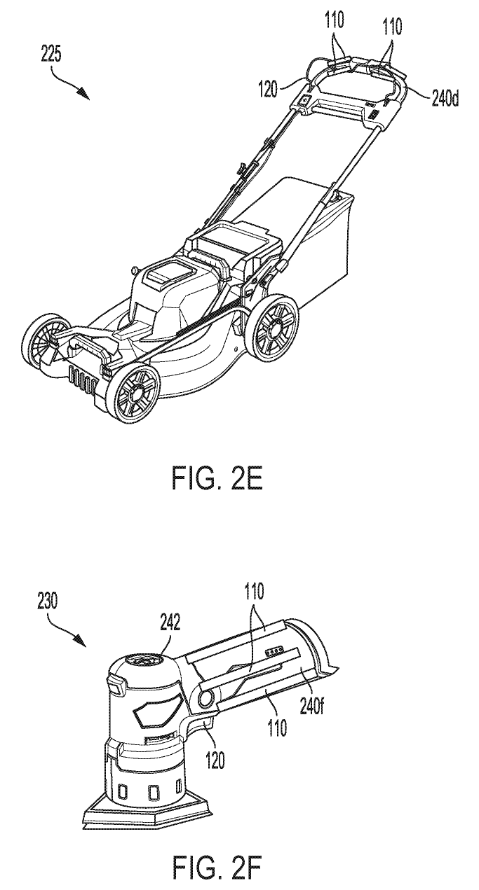

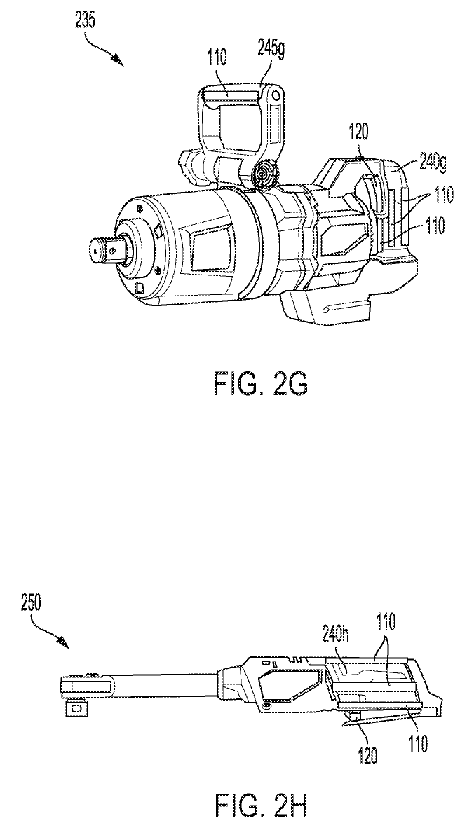

FIGS. 2A-H illustrate several example embodiments of power tools equipped with one or more force sensors 110. Each of the tools in FIGS. 2A-2H is another respective example of the power tool 100 described with respect to FIGS. 1A-B, 3, and 4, but implemented as a different type of power tool than the drill-driver of FIGS. 1A-B. In particular, FIGS. 2A-H show a hammer drill 205, a right angle drill 210, reciprocating saw 215, a circular saw 220, a lawn mower 225, a sander 230, a high torque impact wrench 235, and an electric ratchet 250, respectively. As illustrated in FIGS. 2A-H, each power tool may include a trigger 120 and multiple force sensors 110 arranged on a handle or grip 240a-h of the tool, and/or on an auxiliary handle or grip 245a-h of the tool. Although a certain number of force sensors 110 are illustrated on each tool in FIGS. 2A-H, in some examples, each power tool may include fewer or more force sensors 110 that may be paired or grouped to form multi-direction force sensors 112, 114 and/or multi-axis force sensors 116, similar to as described with respect to FIGS. 1A-B. For example, a pair of force sensors 110 on opposite sides of a handle or auxiliary handle may be referred to as multi-direction force sensor as the pair of force sensors can together sense forces from multiple (opposite) directions. In some examples, the force sensors 110 may be used to detect a force applied to a tool. For example, the sander 230 may include a force sensor 110 on a top portion of the handle 240f that can detect how hard a user is pushing down (in the example orientation shown in FIG. 2F). In some examples of the sander 230, an additional force sensor 110 may be positioned on a top side of the main body 242 to detect user pressing force on the sander 230. Further, a multi-axis force sensor may include a group of four force sensors 110 on different sides of a handle or auxiliary handle as these force sensors 110 can together sense forces from multiple axes (e.g., orthogonal axes).

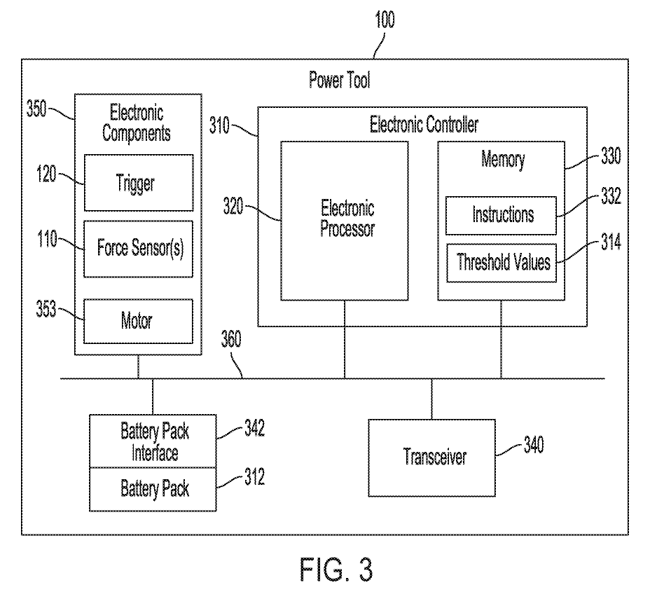

FIG. 3 illustrates a block diagram of a power tool 100 with one or more multi-direction force sensors formed from force sensors 110. The block diagram of FIG. 3 may apply to the power tool 100 of FIGS. 1A-B, as well as to each of the power tools illustrated in FIGS. 2A-G. In some examples, the power tool 100 may include an electronic controller 310, a transceiver 340, a power tool battery pack 312, and/or electronic components 350. The electronic controller 310 may include an electronic processor 320 and a memory 330. The electronic processor 320, the memory 330, and the transceiver 340 may communicate over one or more control and/or data buses (for example, a device communication bus 360). The memory 330 may include read-only memory (ROM), random access memory (RAM), other non-transitory computer-readable media, or a combination thereof. The memory 330 may include instructions 332 for the electronic processor 320 to execute.

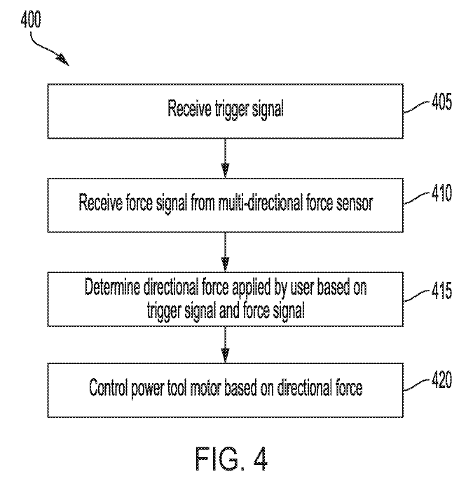

The electronic processor 320 may be configured to communicate with the memory 330 to store data and retrieve stored data. The electronic processor 320 may be configured to receive the instructions 332 and data from the memory 330 and execute, among other things, the instructions 332. In some examples, through execution of the instructions 332 by the electronic processor 320, the electronic controller 310 may perform one or more of the methods described herein. For example, the instructions 332 may include software executable by the electronic processor 320 to enable the electronic controller 310 to, among other things, implement the various functions of the electronic controller 310 described herein, including the functions of the electronic controller 310 described with respect to process 400 of FIG. 4.

In some examples, the memory 330 may store one or more threshold values 314. The threshold values 314 may correspond to zero thresholds, or specific force values corresponding to an amount of force detected by force sensors 110 while a user is holding the tool (e.g., and not applying a pushing force, pulling force, etc.). Zero thresholds may also be referred to as baseline thresholds or baseline force thresholds. The threshold values 314 may further include other thresholds referred to herein, including kickback force threshold(s) and rotation threshold(s). The electronic controller 310 may access these threshold values 314 when performing one or more of the methods described herein. For example, the instructions 332 may include steps that compare real-time values from the force sensor(s) 110 to the threshold values 314 stored in the memory 330.

The transceiver 340 may be communicatively coupled to the electronic controller 310 (e.g., via the bus 360). The transceiver 340 enables the electronic controller 310 (and, thus, the power tool 100) to communicate with other devices (e.g., an external device).

In some embodiments, the power tool 100 may also optionally include a power tool battery pack interface 342 that is configured to selectively receive and interface with a power tool battery pack 312. With reference to FIGS. 1A-B, the power tool battery pack interface 342 may be located at the foot 108 of the power tool 100. The pack interface 342 may include one or more power terminals and, in some cases, one or more communication terminals that interface with respective power and/or communication terminals of the power tool battery pack 312. The power tool battery pack 312 may include one or more battery cells of various chemistries, such as lithium-ion (Li-Ion), nickel cadmium (Ni-Cad), and the like. The power tool battery pack 312 may further selectively latch and unlatch (e.g., with a spring-biased latching mechanism) to the power tool 100 to prevent unintentional detachment. The power tool battery pack 312 may further include a pack electronic controller (pack controller) including a processor and a memory. The pack controller may be configured similarly to the electronic controller 310 of the power tool 100. The pack controller may be configured to regulate charging and discharging of the battery cells, and/or to communicate with the electronic controller 310. In other embodiments, the one or more power terminals of the pack interface 342 can interface with the mains electricity to operate the power tool 100. It should be appreciated that the power source for the power tool 100 is not limited to the battery pack 312 and can include any other suitable power source (e.g., mains electricity). With reference to FIG. 2B, an example of a power tool battery pack similar to the power tool battery pack 312 is illustrated as coupled to the right angle drill 210, and an example of a mains (corded) power supply is illustrated as coupled to the saw 215 in FIG. 2C.

In some embodiments, the power tool 100 also includes additional electronic components 350. In some examples, the electronic component 350 may include one or more force sensors 110 and a motor 353. The force sensor(s) 110 may be as described above with respect to FIGS. 1A-B and 2A-2G. Thus, for example, one or more pairs of the force sensors 110 may be paired to form one or more multi-direction force sensors of the handle 102 and/or the auxiliary handle 118 of the power tool 100. Additionally, for example, one or more groups of the force sensors 110 (or of the multi-direction force sensors) may grouped to form one or more multi-axis force sensors of the power tool 100.

The electronic components 350 may also include additional circuitry to control the motor 353. For example, the electronic components 350 may include an inverter bridge controlled with pulse width modulated signals (generated by the controller 310) to drive the motor 353. The motor 353 may be, for example, a brushed or brushless motor.

FIG. 4 illustrates a flowchart of process 400 for controlling a power tool motor based on a directional force. For illustration purposes, the process 400 is generally described as being implemented by the power tool 100 of FIG. 1A-B and, more particularly, with the components of the power tool 100 described in FIG. 3. However, in some embodiments, the process 400 is implemented by one of the examples of the power tool 100 illustrated in FIGS. 2A-G as power tools 205-235, or another power tool not illustrated, or another system having additional components, fewer components, alternative components, etc. Although the blocks of the process 400 are illustrated in a particular order, in some embodiments, one or more of the blocks can be executed partially or entirely in parallel, can be executed in a different order than illustrated in FIG. 4, or can be bypassed.

In block 405, a trigger signal is received from a trigger on a power tool. For example, with reference to FIG. 3, a trigger signal may be received by the electronic controller 310 from the trigger 120. In some examples, the trigger signal may correspond to an actuation signal generated by a switch within the trigger 120. The actuation signal may indicate a depression or actuation of the trigger (e.g., by a user).

In block 410, a force signal is received from one or more multi-direction force sensors of a handle of the power tool. For example, with reference to FIG. 3 the force signal may be generated by one or more multi-direction force sensors of the force sensors 110 and may be received by the controller 310 from these one or more multi-direction force sensors. The one or more multi-direction force sensors may be positioned in the handle 102 of the power tool 100 and/or the auxiliary handle 118 of the power tool 100 as illustrated in FIGS. 1A-B, or a handle or auxiliary handle of the power tools 200-235 of FIGS. 2A-G.

In some examples, the force signal may include one or more force values. In particular, a first force value and a second force value may be received, with the first force value indicating a force in the opposite direction as the second force value. For example, the controller 310 may receive the first force value from the force sensor 110a of the multi-direction force sensor 112 and the second force value from the force sensor 110b of the multi-direction force sensor 112. The force signal may comprise the first force value and the second force value, which may be transmitted separately to the controller 310 by each respective force sensor 110a-b or may be combined and transmitted together (e.g., summed, concatenated, subtracted from one another, etc.).

Moreover, a third force value and a fourth force value may also be received, with the third force value being in the opposite direction as the fourth force value. The third and fourth force values may be in perpendicular directions as the first and second force values, respectively. For example, the controller 310 may receive the third force value from the force sensor 110c of the multi-direction force sensor 114 and the fourth force value from the force sensor 110d of the multi-direction force sensor 114. The force signal may comprise the first, second, third, and fourth force values. The third force value and the fourth force value may be transmitted separately to the controller 310 by each respective force sensor 110c-d or may be combined and transmitted together (e.g., summed, concatenated, subtracted from one another, etc.). In some examples, the force signal received by the controller includes the third and fourth force values, but not the first and second force values. In some examples, the force signal includes further force values in addition to the first, second, third, and fourth force values.

For example, the first and second force values may correspond to a force applied to the front and back face of a power tool handle (e.g., handle 102, auxiliary handle 118, handle 240a-g, auxiliary handle 245a-g), respectively, while the third and fourth force values may correspond to forces applied to the left and right side of the power tool handle.

In some examples, the force signal received may be a non-binary value. For example, the force signal may be a value between 0 and 10, with a force signal value of 0 indicating no force detected and a force signal value of 10 indicating a maximum force value reading. In other examples, a different scale is used. In some examples, the force signal may include one or more values corresponding to a direct measurement obtained by the force sensors 110.

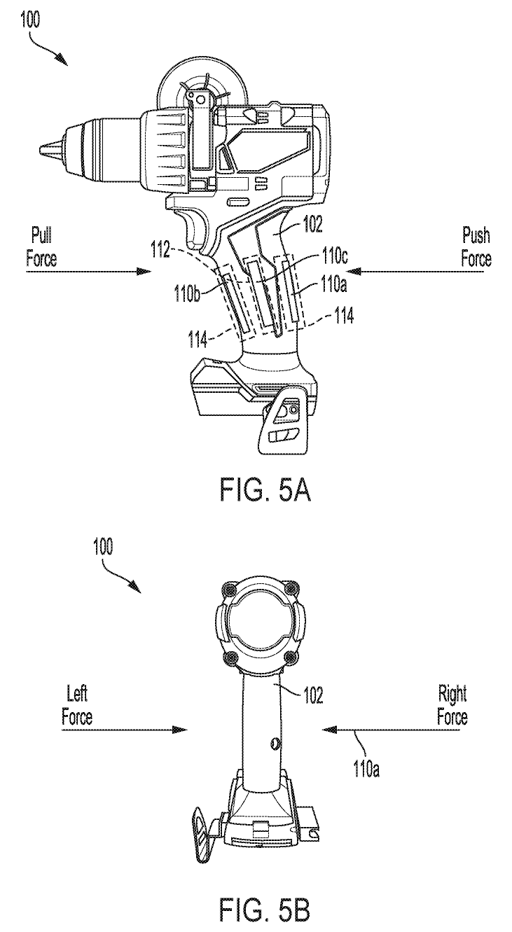

In block 415, a directional force applied by a user to the power tool is determined based on the trigger signal and the force signal. For example, the controller 310 may determine the directional force upon receipt of both the trigger signal and the force signal (e.g., in blocks 405 and 410). In some examples, in response to receiving the trigger signal (in block 405), the controller 310 may receive the force signal (in block 410), and upon receipt of the force signal in block 410, the controller 310 may determine the directional force in block 415. In some examples, the directional force may be expressed as a direction of force (e.g., a pull force, a push force, a leftward force, a rightward force, or a combination thereof). FIGS. 5A-B illustrate examples of the pull force, push force, leftward force, and rightward force acting on the handle 102 of the power tool 100. In some examples, the directional force may be indicated or expressed as a vector or vectors, each vector comprising a force direction and a force amount. For example, the directional force may include a force direction such as, for example, a pull force, a push force, a leftward force, a rightward force, or a combination thereof, and a force amount such as, for example, a value indicated in Newtons or on another scale (e.g., 1-10).

To determine the directional force, the controller 310 may perform one or more comparisons. A grip force applied to a front face of the tool handle (e.g., a force value indicated by the force sensor 110b) may be compared to a grip force applied to a back face of the tool handle (e.g., a force value indicated by the force sensor 110a). A front face grip force that exceeds a back face grip force may indicate that a pull directional force is being applied, while a back face grip that exceed a front face grip force may indicate that a push directional force is being applied. In another example, the grip force applied to a front face of the tool handle may be subtracted from a grip force applied to a back face of the tool handle to perform the comparison and/or to determine a directional force as a vector. For example, a positive result to the subtraction may indicate a push directional force is being applied and a negative result may indicate a pull directional force is being applied (or vice versa), and the quantity of the value may indicate an amount of force in the determined direction. A similar comparison and/or subtraction for the force sensors 110c and 110d of the multi-direction force sensor 114 may be performed to determine a directional force in the left direction or right direction and/or an amount of the force in the determined direction.

In some examples, in block 415, the controller 310 determines a directional force in the push-pull direction axis, in the left-right direction axis, or both in the push-pull and the left-right direction axes.

In some examples, to determine the directional force in block 415, in addition to comparing the grip force applied to the front and back faces (or left and right faces), the controller 310 also compares the grip force to a zero threshold for the corresponding direction. Each direction or force sensor 110 may have a corresponding zero threshold (e.g., a rear zero threshold, front zero threshold, left zero threshold, right zero threshold), where each zero threshold may represent a neutral grip force (or baseline grip force) for the corresponding force sensor 110 or direction when the user grips the power tool 100. Then, as an example, to determine that a push directional force is present, the controller 310 may both (i) determine that the grip force applied to the back face of the tool handle is greater than the grip force applied to the front face of the tool handle, and (ii) determine that the grip force applied to the back face of the tool handle is greater than a rear zero threshold. If either condition is false, the controller 310 may determine that a push directional force is not present. This additional zero threshold condition may reduce the controller 310 from determining a directional force is present based on slight relative differences between opposite forces on the tool handle (e.g., front versus rear forces).

The controller 310 may implement similar conditions for each direction. Accordingly, for example, to determine that a pull directional force is present, the controller 310 may both (i) determine that the grip force applied to the front face of the tool handle is greater than the grip force applied to the back face of the tool handle, and (ii) determine that the grip force applied to the front face of the tool handle is greater than a front zero threshold. Similarly, to determine that a left directional force is present, the controller 310 may both (i) determine that the grip force applied to the left face of the tool handle is greater than the grip force applied to the right face of the tool handle, and (ii) determine that the grip force applied to the left face of the tool handle is greater than a left zero threshold. Similarly, to determine that a right directional force is present, the controller 310 may both (i) determine that the grip force applied to the right face of the tool handle is greater than the grip force applied to the left face of the tool handle, and (ii) determine that the grip force applied to the right face of the tool handle is greater than a right zero threshold.

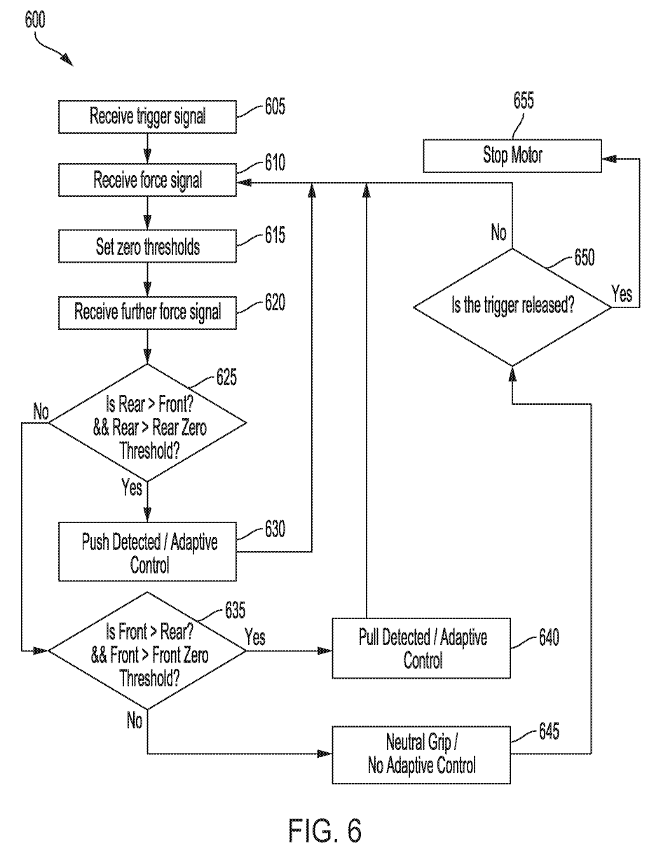

FIG. 6, discussed in further detail below, illustrates an example process 600 that uses similar conditions with zero thresholds and force value comparisons to determine a push and pull directional force (see, e.g., blocks 625 and 635).

In some examples, the controller 310 may obtain one or more of the zero thresholds from one or more of the force sensors 110 of the power tool 100. For example, upon a trigger pull (e.g., in block 405), an initial (or baseline) force value received from each respective sensor of the force sensors 110 may serve as the zero threshold for the respective force sensor 110. In some examples, the controller 310 may obtain one or more of the zero thresholds by determining an average force value indicated by one or more force sensors 110 for each respective direction or force sensor 110. The average force value may be determined during an idle time or during a setup stage of the power tool. With reference to FIG. 3, the controller 310 may store the one or more zero thresholds as the threshold values 314 in the memory 330 and may retrieve the one or more zero thresholds from the memory 330 for use (e.g., in block 415).

In some examples, similar comparison steps may be executed using grip force values detected on a left and/or right face of the handle 102 to determine a leftward force or a rightward force. In some examples, the directional force determined in block 415 may indicate to the controller 310 whether the user is holding tool. In some examples, the directional force determined in block 415 may indicate with which hand (i.e., left or right) the user is holding the tool, as the difference in leftward versus rightward force may correspond to a left versus right handed user.

In block 420, the power tool motor is controlled based on the directional force determined in block 415. For example, with respect to FIG. 3, the electronic controller 310 may change a speed of the motor 353, a direction of the motor 353, start the motor 353, and/or stop the motor 353 based on the determined directional force. This control may provide, at least in some examples, more intuitive control of the power tool 100 by a user.

In some examples, to control the power tool motor based on the directional force in block 420, the controller 310 increases or decreases the speed and/or torque of the motor 353. For example, when the controller 310 determines (at block 415) that a pushing force was being applied to the power tool, the controller 310 may increase a speed and/or torque of the motor 353. Similarly, when the controller 310 determines (at block 415) that a pulling force was being applied to the power tool, the controller 310 may decrease a speed and/or torque of the motor 353. In some examples, the speed and/or torque, and/or the increase/decrease thereto, may be proportional to the amount of push and/or pull force detected. For example, when the controller 310 detects an increase in push force, the controller 310 may proportionally increase the speed and/or torque of the motor 353 with the push force (e.g., the larger the push force, the larger the increase, and vice versa). Alternatively, when the controller 310 detects an increase in pull force, the controller 310 may proportionally decrease the speed and/or torque of the motor 353 with the pull force (e.g., the larger the pull force, the larger the decrease, and vice versa). In such examples, when the push and/or pull amount changes the speed and/or torque of the motor 353, control of the power tool 100 by a user may be more intuitive or precise relative to speed and/or torque control based on trigger pull amount alone.

In some examples, to control the power tool motor based on the directional force in block 420, the controller 310 controls or changes the direction of the motor 353 based on the determined directional force. For example, when the controller 310 determines (at block 415) that a pushing force was being applied to the power tool, the controller 310 may control the motor 353 to rotate in a clockwise direction. Similarly, when the controller 310 determines (at block 415) that a pulling force was being applied to the power tool, the controller 310 may control the motor 353 to rotate in a counterclockwise direction. Additionally, as described above, the controller 310 may control the speed and/or torque of the motor 353 in the clockwise direction or counterclockwise direction, as the case may be, to be proportional to the amount of push or pull force detected. Such control of motor rotation direction based on push and/or pull force may provide intuitive control for threading/tapping or drilling operations of a power tool 100 that is in the form of a drill. For example, a user may push the handle 102 of the power tool 100 to drill a drill bit into a material (or thread a tap bit into a hole in the material) and may pull the handle to reverse the drill bit or tap bit out of the material. In some examples, when the force of the handle 102, or resulting speed or torque of the motor 353, exceeds a high threshold (or falls below a low threshold), the controller 310 may generate an alert to indicate to the user that the feed force is being applied by the user is too high (or too low). The alert may be audible, visible, or tactile feedback output by a speaker, light (e.g., light emitting diode), or vibration element of the power tool 100, or a connected device (e.g., a wirelessly connected smart phone, tablet, or laptop).

As another example of controlling motor direction based on the determined directional force, when the controller 310 determines (at block 415) that a rightward force was being applied to the power tool, the controller 310 may control the motor 353 to rotate in a clockwise direction. Similarly, when the controller 310 determines (at block 415) that a leftward force was being applied to the power tool, the controller 310 may control the motor 353 to rotate in a counterclockwise direction. Additionally, as described above, the controller 310 may control the speed and/or torque of the motor 353 in the clockwise direction or counterclockwise direction, as the case may be, to be proportional to the amount of rightward or leftward force detected. Accordingly, the controller 310 can sense attempt by a user to manually rotate the power tool 100 and control the motor 353 to assist or magnify the manual rotation by the user.

In some examples, to control the power tool motor based on the directional force in block 420, the controller 310 may stop the motor 353 (e.g., cease power supply to the motor 353, brake the motor 353, or the like) based on the determination at block 415. For example, in block 420, the controller 310 may compare a force amount of the directional force determined in block 415 (e.g., a force amount of a leftward or rightward force) to a kickback force threshold. When the force amount exceeds the kickback force threshold, the controller 310 may determine that a kickback event is occurring and may stop the motor 353. Using force sensor data as described can enable the controller 310 to detect that the power tool 100 is bound in a material even when not rotating, which could occur when the power tool 100 or a user’s hand that is operating the power tool 100 is abutting another object (e.g., a wall, a beam, etc.). In some examples, in block 420, the controller 310 compares a change in the force amount (e.g., determined by calculating a difference between two force signals) to a kickback threshold to determine whether a kickback event is occurring. For example, when the change or increase in the force amount (e.g., for a leftward or rightward force) exceeds the kickback threshold, the controller 310 may determine that a kickback event is occurring and may stop the motor 353. In some examples, when a change in the force amount indicates a sudden drop in the force amount (e.g., a negative change in the force amount above a lost grip threshold), the controller 310 may determine that a user is losing grip of the power tool 100 during operation. In such a circumstance, the controller 310 may stop the motor 353.

In some examples, to detect a kickback event, the controller 310 further receives and analyzes additional sensor data in addition to the force signal received in block 410. For example, the power tool 100 may include a motion sensor (e.g., an inertial motion unit (IMU), an accelerometer, a gyroscope, or a combination thereof) that senses and outputs motion experienced by the power tool 100 to the controller 310. For example, the motion sensor may indicate a rotation amount (e.g., in terms of displacement, velocity, and/or acceleration amount) of the power tool 100 about an axis of the power tool 100 (e.g., about a central rotational axis of the motor 353 or another selected axis). In some examples, the controller 310 detects a kickback event in response to determining that both the rotation amount received from the motion sensor exceeds a rotation threshold and the force amount of the directional force determined in block 415 exceeds a kickback force threshold. Further, the applicable rotation threshold may vary inversely relative to the force amount of the directional force. For example, the controller 310 may set the rotation threshold based on the force amount of the direction force, where the rotation threshold is set to a first (higher) value when force amount is at a first level and where the rotation threshold is set to a second (lower) value when the force amount is at a second level that is higher than the first level. Thus, for example, when a higher leftward or rightward force is detected on the handle 102 of the power tool 100 (e.g., above the second level), the controller 310 may detect a kickback event as a result of a smaller rotational movement of the power tool 100 (that exceeds the rotation threshold at the second value) than otherwise would be the case if a lower leftward or rightward force was present. Similarly, the controller 310 may not detect a kickback event as a result of that same (smaller) rotational movement when a lower leftward or rightward force is present on the handle 102; rather, when a lower leftward or rightward force is present on the handle 102, the controller 310 may detect a kickback event when a larger rotational movement occurs that exceeds the first (higher) value.

In some examples, to control the power tool motor based on the directional force in block 420, the controller 310 may enable rotation of the motor 353 (e.g., cease power supply to the motor 353, brake the motor 353, or the like) based on the determination at block 415. That is, the controller 310 may condition providing power to the motor 353 on when a grip is detected. For example, in block 420, the controller 310 may compare force amount of the directional force determined in block 415 (e.g., a force amount of a leftward or rightward force) to a grip threshold. In some examples, the controller 310 conditions providing power to the motor 353 on the force amount for two or more of the force sensors 110 exceeding grip thresholds for these corresponding force sensors 110. When the controller 310 determines that such grip thresholds are exceeded, the controller 310 may control the motor 353 to rotate in response to actuation of the trigger 120. Accordingly, the controller 310 may prevent operation of the power tool 100 from an incidental actuation of the trigger 120 (e.g., within a tool bag) when a user is not gripping the handle 102 of the power tool 100.

In some examples, in block 420, the controller 310 determines whether to perform more than one of the adaptive control actions discussed above with respect to block 420. For example, the controller 310 may compare the directional force (or underlying force values and related calculations) to various thresholds in block 420, and perform the corresponding resulting action based on the comparisons. For example, in block 420, the controller 310 may compare the force amounts or change in force amounts to the grip threshold(s) and kickback threshold(s) and determine whether to stop the motor 353 or whether to power the motor 353. Additionally, or alternatively, in block 420, the controller 310 may determine which direction to rotate the motor 353 and at what speed and/or torque to rotate the motor 353. Accordingly, during a single trigger actuation, the controller 310 may execute the process 400 to determine whether to perform more than one of the adaptive control actions and may perform any one of the adaptive control actions deemed appropriate given the determined directional force.

In some examples, the process 400 loops back to block 410, following block 420, for the controller 310 to receive one or more further force signals from the multi-direction force sensor and proceed back through blocks 415 and 420 with the further force signal(s). In some examples, the process 400 may continue to loop back through blocks 410, 415, and 420 during an operation of the power tool 100 until the trigger 120 is released or deactuated, or until the controller 310 controls the power tool motor 353 to stop.

In some examples, a user of a power tool 100 may be able to enable and disable functionality associated with adaptive tool control method described in FIG. 4. For example, the power tool may include a button positioned on the body of the power tool 100 that a user can toggle on and off to enable or activate the adaptive control method described in FIG. 4. In some examples, the controller 310 may be wirelessly connected to a user device (e.g., a smart phone, tablet, laptop, etc.), which can transmit a signal to the controller 310 and, in response to which, causes the controller 310 to enable or disable the adaptive control method described in FIG. 4.

FIG. 6 illustrates a flowchart of a process 600 for controlling a power tool motor based on a directional force. For illustration purposes, the process 600 is generally described as being implemented by the power tool 100 of FIG. 1A-B and, more particularly, with the components of the power tool 100 described in FIG. 3. However, in some embodiments, the process 600 is implemented by one of the examples of the power tool 100 illustrated in FIGS. 2A-G as power tools 205-235, or another power tool not illustrated, or another system having addition components, fewer components, alternative components, etc. Although the blocks of the process 600 are illustrated in a particular order, in some embodiments, one or more of the blocks can be executed partially or entirely in parallel, can be executed in a different order than illustrated in FIG. 6, or can be bypassed.

In block 605, a trigger signal is received from a trigger on a power tool. For example, with reference to FIG. 3, a trigger signal may be received by the electronic controller 310 from the trigger 120. In some examples, the trigger signal may correspond to an actuation signal generated by a switch within the trigger 120. The actuation signal may indicate a depression or actuation of the trigger (e.g., by a user).

In block 610, a force signal is received from one or more multi-direction force sensors of a handle of the power tool. For example, as described with respect to block 410 of FIG. 4, with reference to FIG. 3, the force signal may be generated by one or more multi-direction force sensors of the force sensors 110 and may be received by the controller 310 from these one or more multi-direction force sensors. For example, the force signal may include a respective force value from each force sensor of the force sensors 110. These force values may be referred to as initial or baseline force values.

In block 615, the controller 310 may set a zero threshold for each respective force sensor 110. For example, the baseline force values for each force sensor 110 may be stored as a respective zero threshold for the corresponding force sensor 110. The controller 310 may store the zero thresholds in the memory 330 as the threshold values 314. For example, the controller 310 may store a rear zero threshold based on a force value from the rear force sensor 110a, a front zero threshold based on a force value from the front force sensor 110b, a left zero threshold based on a force value from the left force sensor 110c, and a right zero threshold based on a force value from the right force sensor 110d.

In block 620, a further force signal is received from one or more multi-direction force sensors of a handle of the power tool. For example, as described with respect to block 410 of FIG. 4, with reference to FIG. 3, the further force signal may be generated by one or more multi-direction force sensors of the force sensors 110 and may be received by the controller 310 from these one or more multi-direction force sensors. In some examples, the further force signal may include a rear force value from the rear force sensor 110a, a front force value from the front force sensor 110b, a left force value from the left force sensor 110c, and/or a right force value from the right force sensor 110d.

In block 625, the controller 310 may determine whether a rear force value of the further force signal is greater than a front force value of the further force signal and may determine whether the rear force value of the further force signal is greater than the rear zero threshold. For example, the controller 310 may compare the various values to make these determinations. When both conditions are true, the controller 310 may proceed to block 630. When either condition is false, the controller 310 may proceed to block 635.

In block 630, the controller 310 may determine or indicate that a directional force applied to the tool handle is a push force. In block 630, the controller 310 may then perform adaptive control of the motor 353 of the power tool 100 in response to determining that the directional force is a push force (e.g., in a manner as described with respect to block 420 of FIG. 4). For example, the controller 310 may increase the speed of the motor 353, increase the torque output by the motor 353, begin driving the motor 353 clockwise, set the speed of the motor 353 proportional to the amount of push force detected, set the torque output by the motor 353 proportional to the amount of push force detected, or a combination thereof.

In block 635, the controller 310 may determine whether a front force value of the further force signal is greater than a rear force value of the further force signal and may determine whether the front force value of the further force signal is greater than the front zero threshold. For example, the controller 310 may compare the various values to make these determinations. When both conditions are true, the controller 310 may proceed to block 640. When either condition is false, the controller 310 may proceed to block 645.

In block 640, the controller 310 may determine or indicate that a directional force applied to the tool handle is a pull force. In block 640, the controller 310 may perform adaptive control of the motor 353 of the power tool 100 in response to determining that the directional force is a pull force (e.g., in a manner as described with respect to block 420 of FIG. 4). For example, the controller 310 may decrease the speed of the motor 353, decrease the torque output by the motor 353, begin driving the motor 353 counterclockwise, set the speed of the motor 353 proportional to the amount of pull force detected, set the torque output by the motor 353 proportional to the amount of pull force detected, or a combination thereof.

In block 645, the controller 310 may determine or indicate that no directional force is currently being applied to the tool handle (e.g., that a user of the power tool has a neutral grip on the power tool 100). In block 645, the controller 310 may control the power tool 100 in a normal (non-adaptive) operation mode (e.g., control the motor 353 without modification based on the force signal from the force sensors 110). For example, in such a non-adaptive mode, the controller 310 may control the power applied to the motor 353 (and, thus, the speed and/or torque output) in proportion to the amount of trigger pull of the trigger 120.

In block 650, the controller 310 may determine whether the trigger is released. For example, with reference to FIG. 3, a trigger signal may be received by the electronic controller 310 from the trigger 120 when depressed, and no trigger signal (or a different trigger signal) may be received from the trigger 120 when the trigger 120 is released. When the controller 310 determines that the trigger is released, in block 655, the controller 310 may cease operation of the motor 353 (e.g., stop motor rotation). When the controller 310 determines that the trigger 120 is not released (e.g., remains actuated), the controller 310 returns to block 620 to receive a further force signal from the force sensors 110.

Although the process 600 of FIG. 6 is described with respect to the front and rear force sensors 110a, 110b, in some examples, a similar process is applied with respect to the left and right force sensors (e.g., sensors 110c, 110d). For example, in blocks 625, the controller 310 may compare the left and right force values and may compare the left force value to a left zero threshold to determine whether a leftward force is present in block 630, and in block 635, the controller 310 may compare right and left force values and may compare the right force value to a right zero threshold to determine whether a rightward force is present in block 640. In such modified blocks 630 and 640, the controller 310 may implement adaptive control of the motor 353 as described with respect to block 420 of FIG. 4 when such leftward and/or rightward force is detected on the tool handle of the power tool 100. Further, in some examples, a similar process is applied with respect to both front and rear force sensors 110a, 110b and also left and right force sensors 110c, 110d, such that the controller 310 may detect a push force, a pull force, a leftward force, and/or a rightward force and may, in response, implement adaptive control corresponding to the detected force.

It is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

As used herein, unless otherwise limited or defined, discussion of particular directions is provided by example only, with regard to particular embodiments or relevant illustrations. For example, discussion of “top,” “front,” or “back” features is generally intended as a description only of the orientation of such features relative to a reference frame of a particular example or illustration. Correspondingly, for example, a “top” feature can sometimes be disposed below a “bottom” feature (and so on), in some arrangements or embodiments. Further, references to particular rotational or other movements (e.g., counterclockwise rotation) is generally intended as a description only of movement relative to a reference frame of a particular example of illustration.

In some embodiments, including computerized implementations of methods according to the disclosure, can be implemented as a system, method, apparatus, or article of manufacture using standard programming or engineering techniques to produce software, firmware, hardware, or any combination thereof to control a processor device (e.g., a serial or parallel processor chip, a single- or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, embodiments of the disclosure can be implemented as a set of instructions, tangibly embodied on a non-transitory computer-readable media, such that a processor device can implement the instructions based upon reading the instructions from the computer-readable media. Some embodiments of the disclosure can include (or utilize) a control device such as an automation device, a computer including various computer hardware, software, firmware, and so on, consistent with the discussion below. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.). Also, functions performed by multiple components can be consolidated and performed by a single component. Similarly, the functions described herein as being performed by one component can be performed by multiple components in a distributed manner. Additionally, a component described as performing particular functionality can also perform additional functionality not described herein. For example, a device or structure that is “configured” in a certain way is configured in at least that way, but can also be configured in ways that are not listed.

The term “article of manufacture” as used herein is intended to encompass a computer program accessible from any computer-readable device, carrier (e.g., non-transitory signals), or media (e.g., non-transitory media). For example, computer-readable media can include but are not limited to magnetic storage devices (e.g., hard disk, floppy disk, magnetic strips, and so on), optical disks (e.g., compact disk (CD), digital versatile disk (DVD), and so on), smart cards, and flash memory devices (e.g., card, stick, and so on). Additionally, it should be appreciated that a carrier wave can be employed to carry computer-readable electronic data such as those used in transmitting and receiving electronic mail or in accessing a network such as the Internet or a local area network (LAN). Those skilled in the art will recognize that many modifications can be made to these configurations without departing from the scope or spirit of the claimed subject matter.

Certain operations of methods according to the disclosure, or of systems executing those methods, can be represented schematically in the figures or otherwise discussed herein. Unless otherwise specified or limited, representation in the figures of particular operations in particular spatial order can not necessarily require those operations to be executed in a particular sequence corresponding to the particular spatial order. Correspondingly, certain operations represented in the figures, or otherwise disclosed herein, can be executed in different orders than are expressly illustrated or described, as appropriate for particular embodiments of the disclosure. Further, in some embodiments, certain operations can be executed in parallel, including by dedicated parallel processing devices, or separate computing devices configured to interoperate as part of a large system.

As used herein in the context of computer implementation, unless otherwise specified or limited, the terms “component,” “system,” “module,” etc. are intended to encompass part or all of computer-related systems that include hardware, software, a combination of hardware and software, or software in execution. For example, a component can be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) can reside within a process or thread of execution, can be localized on one computer, can be distributed between two or more computers or other processor devices, or can be included within another component (or system, module, and so on).

In some implementations, devices or systems disclosed herein can be utilized or installed using methods embodying aspects of the disclosure. Correspondingly, description herein of particular features, capabilities, or intended purposes of a device or system is generally intended to inherently include disclosure of a method of using such features for the intended purposes, a method of implementing such capabilities, and a method of installing disclosed (or otherwise known) components to support these purposes or capabilities. Similarly, unless otherwise indicated or limited, discussion herein of any method of manufacturing or using a particular device or system, including installing the device or system, is intended to inherently include disclosure, as embodiments of the disclosure, of the utilized features and implemented capabilities of such device or system.

As used herein, unless otherwise defined or limited, ordinal numbers are used herein for convenience of reference based generally on the order in which particular components are presented for the relevant part of the disclosure. In this regard, for example, designations such as “first,” “second,” etc., generally indicate only the order in which the relevant component is introduced for discussion and generally do not indicate or require a particular spatial arrangement, functional or structural primacy or order.

As used herein, unless otherwise defined or limited, directional terms are used for convenience of reference for discussion of particular figures or examples. For example, references to downward (or other) directions or top (or other) positions can be used to discuss aspects of a particular example or figure, but do not necessarily require similar orientation or geometry in all installations or configurations.

As used herein, unless otherwise defined or limited, the phase "and/or" used with two or more items is intended to cover the items individually and the items together. For example, a device having “a and/or b" is intended to cover: a device having a (but not b); a device having b (but not a); and a device having both a and b.

This discussion is presented to enable a person skilled in the art to make and use embodiments of the disclosure. Various modifications to the illustrated examples will be readily apparent to those skilled in the art, and the generic principles herein can be applied to other examples and applications without departing from the principles disclosed herein. Thus, embodiments of the disclosure are not intended to be limited to embodiments shown, but are to be accorded the widest scope consistent with the principles and features disclosed herein and the claims below. The following detailed description is to be read with reference to the figures, in which like elements in different figures have like reference numerals. The figures, which are not necessarily to scale, depict selected examples and are not intended to limit the scope of the disclosure. Skilled artisans will recognize the examples provided herein have many useful alternatives and fall within the scope of the disclosure.

Various features and advantages of the disclosure are set forth in the following claims.

1. A method for controlling a power tool, the method comprising:
receiving, via a trigger on the power tool, a trigger signal;
receiving, via an electronic processor, a force signal from a multi-direction force sensor of a handle of the power tool;
determining, based on the force signal and the trigger signal, a directional force applied to the power tool by a user; and
controlling a motor of the power tool based on the directional force.

2. The method of claim 1, wherein the multi-direction force sensor comprises more than one force sensor.

3. The method of claim 1, wherein the force signal comprises:
a first force value; and
a second force value,
the first force value opposite from the second force value.

4. The method of claim 3, further comprising:
comparing the first force value to the second force value to determine the directional force,
wherein controlling the motor of the power tool based on the directional force comprises:
causing the motor to turn in a counter-clockwise direction when the first force value is greater than the second force value, and
causing the motor to turn in a clockwise direction when the second force value is greater than the first force value.

5. The method of claim 3, wherein the first force value indicates a push force and the second force value indicates a pull force, and
wherein the force signal further comprises:
a third force value indicating a leftward force; and
a fourth force value indicating a rightward force.

6. The method of claim 5, further comprising:
comparing the third force value to the fourth force value to determine the directional force; and
detecting that the power tool is bound in a material based on the comparison,
wherein controlling the motor of the power tool based on the directional force comprises:
stopping movement of the motor in response to detecting that the power tool is bound in the material.

7. The method of claim 1, wherein the directional force is at least one of a push force, a pull force, a leftward force, or a rightward force.

8. The method of claim 1, further comprising:
receiving, via the electronic processor, a baseline force value from a force sensor of the multi-direction force sensor;
setting a zero threshold for the force sensor based on the baseline force value; and
determining whether a force amount of the directional force exceeds the zero threshold,
wherein controlling the motor of the power tool is further based on determining that the force amount of the directional force exceeds the zero threshold.

9. The method of claim 8, wherein controlling the motor of the power tool includes increasing a speed, a torque, or both a speed and torque of the motor.

10. The method of claim 1, further comprising:
comparing the force signal to one or more predetermined threshold values; and
determining that the directional force is a push force or a pull force based on the comparison.

11. A power tool multi-direction force sensor system, the system comprising:
a multi-direction force sensor;
a power tool comprising:
a motor;
a trigger; and
an electronic controller including a processor and coupled to the multi-direction force sensor, the motor, and the trigger, the electronic controller configured to:
receive a trigger signal from the trigger;
receive a force signal from the multi-direction force sensor;
determine a directional force applied to the power tool by a user based on the force signal and the trigger signal; and
control the motor based on the directional force.

12. The system of claim 11, wherein the multi-direction force sensor comprises more than one force sensor; and
wherein the force signal indicates at least two of a push force, a pull force, a leftward force, or a rightward force.

13. The system of claim 11, wherein the force signal comprises:
a first force value from a first force sensor of the multi-direction force sensor;
a second force value from a second force sensor of the multi-direction force sensor; and
a third force value from a third force sensor of the multi-direction force sensor,
wherein the first, second, and third force sensors are spaced apart from one another by more than 100 degrees around a handle of the power tool.

14. The system of claim 11, wherein the multi-direction force sensor comprises at least one of a force sensitive resistor (FSR), a strain gauge, an inductive sensor, or a capacitive pressure sensor.

15. The system of claim 11, wherein the force signal comprises:
a first force value; and
a second force value,
the first force value opposite from the second force value.

16. The system of claim 15, wherein the force signal further comprises:
a third force value; and
a fourth force value,
the third force value opposite from the fourth force value and perpendicular to the first force value.

17. The system of claim 16,
wherein the multi-direction force sensor comprises a first force sensor arranged in a front side of a handle of the power tool and a second force sensor arranged in a back side of the handle of the power tool; and
wherein the first force value corresponds to the first force sensor and the second force value corresponds to the second force sensor.

18. The system of claim 17,
wherein the multi-direction force sensor further comprises a third force sensor arranged in a right side of the handle of the power tool and a fourth force sensor arranged in a left side of the handle of the power tool; and
wherein the third force value corresponds to the third force sensor and the fourth force value corresponds to the fourth force sensor.

19. The system of claim 17, wherein the handle is a main handle that includes the trigger.

20. The system of claim 17, wherein the power tool further includes a main handle with the trigger, and wherein the handle is an auxiliary handle that is separate from the main handle.
